(19) United States
(12) Patent Application Publication
(10) Pub. No.: US 2021/0387469 A1
(43) Pub. Date: Dec. 16, 2021

(54) WATERMARK RECORDING DEVICE, WATERMARK DETECTION DEVICE, WATERMARK RECORDED PRINTED MATTER, AND METHOD AND PROGRAM

(71) Applicant: SONY GROUP CORPORATION, TOKYO (JP)

(72) Inventor: TUO ZHUANG, TOKYO (JP)

(21) Appl. No.: 17/309,325

(22) PCT Filed: Nov. 21, 2019
(86) PCT No.: PCT/JP2019/045697

§ 371 Date: May 19, 2021

(30) Foreign Application Priority Data
Nov. 28, 2018 (JP) 2018-222738

(51) Int. Cl. B42D 25/333; B41M 3/14; B42D 25/378

(52) U.S. Cl. CPC B42D 25/333; B42D 25/378; B41M 3/144

(57) ABSTRACT

A device and a method that achieve a watermark that can be easily recorded and does not significantly impair the appearance of a printed matter are provided. A watermark recording unit (214) that records watermark dots having a color having a small difference from an area color of an area in which a watermark is recorded, and a watermark recording mode determination unit (213) that determines a color of the watermark dots are included. The watermark recording mode determination unit (213) determines a color of the watermark dots in such a way that a wavelength difference Δλ, which is a difference between a color wavelength of the watermark dots and an area color wavelength of a recording area of the watermark dots, is less than a wavelength resolution of human eye. Moreover, the color of the watermark dots is determined in such a way that the wavelength difference Δλ is equal to or higher than a wavelength resolution of a spectroscopic camera (hyperspectral camera) (141) that captures an image for watermark analysis.

### TECHNICAL FIELD

The present disclosure relates to a watermark recording device, a watermark detection device, a watermark recorded printed matter, and a method and a program. More specifically, the present disclosure relates to a watermark recording device, a watermark detection device, a watermark recorded printed matter, and a method and a program utilizing human perceptual characteristics.

### BACKGROUND ART

There may be cases where “watermarks” are recorded on important printed matters such as banknotes, securities, and contract documents to prevent counterfeiting.

Note that as a conventional technique that discloses a watermark recording method and a detection method, there is, for example, Patent Document 1 (Japanese Patent Application Laid-Open No. 2017-206792) or the like.

There are various methods for recording watermarks. For example, a method of pressing paper so as to change the thickness of the paper according to a watermark pattern is used in a paper manufacturing process. Furthermore, a method of printing a certain image pattern that is difficult to see on a printed matter is also used.

However, the method of pressing paper so as to change the thickness of the paper requires a special treatment at the time of manufacturing the paper, which causes a problem of high cost.

On the other hand, the configuration for printing the certain image pattern that is difficult to see on a printed matter also requires a special printing device, and has a problem that the appearance of the printed matter may be spoiled.

### CITATION LIST

### Patent Document

Patent Document 1: Japanese Patent Application Laid-Open No. 2017-206792

### Non-Patent Document

Non-Patent Document 1: “On the Hue Discrimination of the Spectrum Color” by Hiroshi Takasaki and Ryuichi Hioki, Journal of the Illumination Engineering Institute of Japan, 1955, Vol. 39, No. 5, pp. 230-235 (https://www.jstage.jst.go.jp)/article/jieij1917/39/5/39_5_230/_pdf/-char/ja)

### SUMMARY OF THE INVENTION

### Problems to be Solved by the Invention

The present disclosure has been made in view of the problems described above, for example, and has an object to provide a watermark recording device, a watermark detection device, a watermark recorded printed matter, and a method and a program that can easily perform recording without using a special dedicated device and do not significantly impair the appearance of a printed matter.

### Solutions to Problems

A first aspect of the present disclosure resides in a watermark recording device including a watermark recording unit that records watermark dots having a color having a small difference from an area color of an area in which a watermark is recorded.

Moreover, a second aspect of the present disclosure resides in a watermark detection device having:

a spectroscopic camera-captured image acquisition unit that acquires a captured image obtained by capturing a watermark recorded printed matter on which watermark dots are recorded by a spectroscopic camera;

a reference image acquisition unit that acquires a reference that is an image of a printed matter on which the watermark dots are not recorded; and

a watermark information extraction unit that calculates a difference between the captured image and the reference image and detects the watermark dots.

Moreover, a third aspect of the present disclosure resides in a watermark recorded printed matter including watermark dots that are recorded thereon and have a color having a small difference from an area color of a print data area in the printed matter.

Moreover, a fourth aspect of the present disclosure resides in a watermark recording method executed in a watermark recording device, the method having, by a watermark recording unit, recording watermark dots having a color having a small difference from an area color of an area in which a watermark is recorded.

Moreover, a fifth aspect of the present disclosure resides in a watermark detection method executed by a watermark detection device, the method including:

a step in which a spectroscopic camera-captured image acquisition unit acquires a captured image obtained by capturing a watermark recorded printed matter on which watermark dots are recorded by a spectroscopic camera;

a step in which a reference image acquisition unit acquires a reference that is an image of a printed matter on which the watermark dots are not recorded; and

by a watermark information extraction unit, calculating a difference between the captured image and the reference image and detecting the watermark dots.

Moreover, a sixth aspect of the present disclosure resides in a program that causes a watermark recording device to execute a watermark recording process including causing a watermark recording unit to record watermark dots having a color having a small difference from an area color of an area in which a watermark is recorded.

Moreover, a seventh aspect of the present disclosure resides in a program that causes a watermark detection device to execute a watermark detection process including:

a step of causing a spectroscopic camera-captured image acquisition unit to acquire a captured image obtained by capturing a watermark recorded printed matter on which watermark dots are recorded by a spectroscopic camera;

a step of causing a reference image acquisition unit to acquire a reference that is an image of a printed matter on which the watermark dots are not recorded; and

causing a watermark information extraction unit to calculate a difference between the captured image and the reference image and detect the watermark dots.

Note that a program of the present disclosure is a program that can be provided by, for example, a storage medium or a communication medium provided in a computer-readable format to an information processing apparatus or a computer system that can execute various program codes. By providing such a program in a computer-readable format, processing corresponding to the program is implemented on the information processing apparatus or the computer system.

Other objects, features, and advantages of the present disclosure will become apparent from a more detailed description based on embodiments of the present disclosure described below and the accompanying drawings. Note that a system in the present description is a logical set configuration of a plurality of devices, and is not limited to one in which devices with respective configurations are in the same housing.

### EFFECTS OF THE INVENTION

With a configuration of one embodiment of the present disclosure, there is provided a device and a method that achieve a watermark that can be easily recorded and does not significantly impair the appearance of a printed matter.

Specifically, for example, a watermark recording unit that records watermark dots having a color having a small difference from an area color of an area in which a watermark is recorded, and a watermark recording mode determination unit that determines a color of the watermark dots are included. The watermark recording mode determination unit determines a color of the watermark dots in such a way that a wavelength difference Δλ, which is a difference between a color wavelength of the watermark dots and an area color wavelength of a recording area of the watermark dots, is less than a wavelength resolution of human eye. Moreover, the color of the watermark dots is determined in such a way that the wavelength difference Δλ is equal to or higher than a wavelength resolution of a spectroscopic camera (hyperspectral camera) that captures an image for watermark analysis.

This configuration provides a device and a method for achieving a watermark recording process and a detection process by which both the recording process and the detection process are easy.

Note that effects described in the present description are merely examples and are not limited, and additional effects may be provided.

### BRIEF DESCRIPTION OF DRAWINGS

FIG. 1 is a diagram describing a specific example of a tint block watermark.

FIG. 2 is a diagram describing a specific example of a font watermark.

FIG. 3 is a diagram describing a configuration using special paint or fiber.

FIG. 4 is a diagram describing a cross-sectional configuration of a human eyeball.

FIG. 5 is a diagram describing a correspondence between a human color sensing ability, that is, “wavelength resolution” of light and a “viewing angle”.

FIG. 6 is a diagram describing a correspondence between the human color sensing ability, that is, the “wavelength resolution” of light and “retinal illuminance T”.

FIG. 7 is a diagram describing an example of a watermark dot color determination process in a case of recording a watermark dot.

FIG. 8 is a diagram describing a specific example of a watermark recording process executed by a watermark recording device of the present disclosure.

FIG. 9 is a diagram describing a configuration example of the watermark recording device of the present disclosure.

FIG. 10 is a diagram illustrating a flowchart describing a sequence of processing executed by the watermark recording device of the present disclosure.

FIG. 11 is a diagram describing a specific example of a watermark detection process executed by the watermark detection device of the present disclosure.

FIG. 12 is a diagram describing a specific example of the watermark detection process executed by the watermark detection device of the present disclosure.

FIG. 13 is a diagram describing a specific example of the watermark detection process executed by the watermark detection device of the present disclosure.

FIG. 14 is a diagram describing a configuration example of the watermark detection device of the present disclosure.

FIG. 15 is a diagram illustrating a flowchart describing a sequence of processing executed by the watermark detection device of the present disclosure.

FIG. 16 is a diagram describing a hardware configuration example of the watermark recording device and the watermark detection device.

### MODE FOR CARRYING OUT THE INVENTION

Hereinafter, details of a watermark recording device, a watermark detection device, a watermark recorded printed matter, and a method and a program of the present disclosure will be described with reference to the drawings. Note that the description will be made according to the following items.

1. Overview of watermark recording process and detection process

2. Visual characteristics of human for colors

3. Watermark recording process executed by watermark recording device of present disclosure

4. Configuration of watermark recording device of present disclosure and sequence of processing to be executed

5. Watermark detection process executed by watermark detection device of present disclosure

6. Configuration of watermark detection device of present disclosure and sequence of processing to be executed

7. Other embodiments

8. Hardware configuration example of watermark recording device and watermark detection device

9. Summary of configuration of present disclosure

### 1. Overview of Watermark Recording Process and Detection Process

First, an outline of a watermark recording process and detection process will be described.

As mentioned above, there may be cases where “watermarks” are recorded on important printed matters such as banknotes, securities, and contract documents to prevent counterfeiting.

Compared to electronic media or the like, paper media cannot be encrypted or electronically secured, and thus have a high risk of information leakage. By recording a watermark on a printed matter, it is possible to reduce the risk of information leakage.

The following effects can be obtained by recording a watermark on a printed matter.

For example, three security effects as follows are expected.

(a) “Authenticity confirmation effect” that allows recognizing differences between an original with a recorded watermark and a copy without the recorded watermark,

(b) “Psychological suppression effect” to suppress information leakage actions,

(c) “Tracking effect” for tracking fraudulent distributors.

For example, as a data recording method for printed matter that exerts these three security effects, for example, there are the following methods.

(1) Superimposition printing

(2) Tint block printing

(3) Tint block watermark

(4) Font watermark

(5) Watermark recording configuration using special paint or fiber

(1) Superimposition printing is, for example, a method of recording information that can always be visually recognized, similarly to normal print data, such as header and footer information. For example, texts such as “copy prohibited” and “take-out prohibited” are recorded as header information.

(2) Tint block printing cannot be visually recognized in a normal visual recognition state, but when a copy process by a copier is performed, characters and the like that can be visually recognized appear on the copied sheet. For example, characters such as “COPY” and “duplicate” appear on the copied sheet. This makes it possible to distinguish between the original and the copy.

(3) Tint block watermark is a watermark recording method that embeds information that cannot be recognized in a normal visual recognition state in a background tint block.

(4) Font watermark is a watermark recording method that embeds information that cannot be recognized in a normal visual recognition state in a normal print font.

(5) Watermark recording configuration using special paint or fiber is a method used, for example, for banknotes or the like, and is a method using, for example, printing or a sheet using paint or fiber that is invisible in visible light but can be detected by infrared rays, ultraviolet rays, or the like other than visible light.

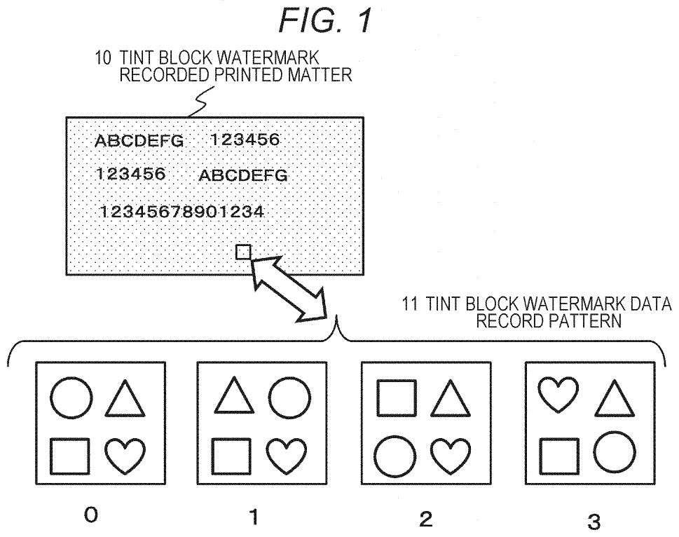

The tint block watermark, font watermark, and watermark recording configuration using special paint or fiber will be described with reference to FIGS. 1 to 3.

FIG. 1 is a diagram illustrating a specific example of the tint block watermark.

As described above, the tint block watermark is a watermark recording method for embedding information that cannot be recognized in a normal visual recognition state in the background tint block.

“ABCDE . . . ” is recorded as a character string that can be visually recognized on a tint block watermark recorded printed matter 10 illustrated in FIG. 1. Moreover, as a background tint block which is a background pattern of this printed matter, a tint block watermark data record pattern 11 illustrated in FIG. 1 is recorded.

The tint block watermark data record pattern 11 illustrated in FIG. 1 is a diagram illustrating an example of a tint block watermark.

The example illustrated in FIG. 1 has a configuration in which four shape patterns of a circle, a triangle, a square, and a heart are arranged.

For example, a pattern with a circle position at the upper left is set as “1”, a pattern with a circle position at the upper right is set as “2”, a pattern with a circle position at the lower left is set as “3”, and a pattern with a circle position at the lower right is set as “4”, and by setting and arranging these patterns, codes 0 to 3 can be recorded as a tint block.

As described above, the tint block watermark is a watermark recording method in which the tint block watermark data record pattern 11 as illustrated in FIG. 1, which cannot be recognized in a normal visual recognition state, is embedded in a background tint block.

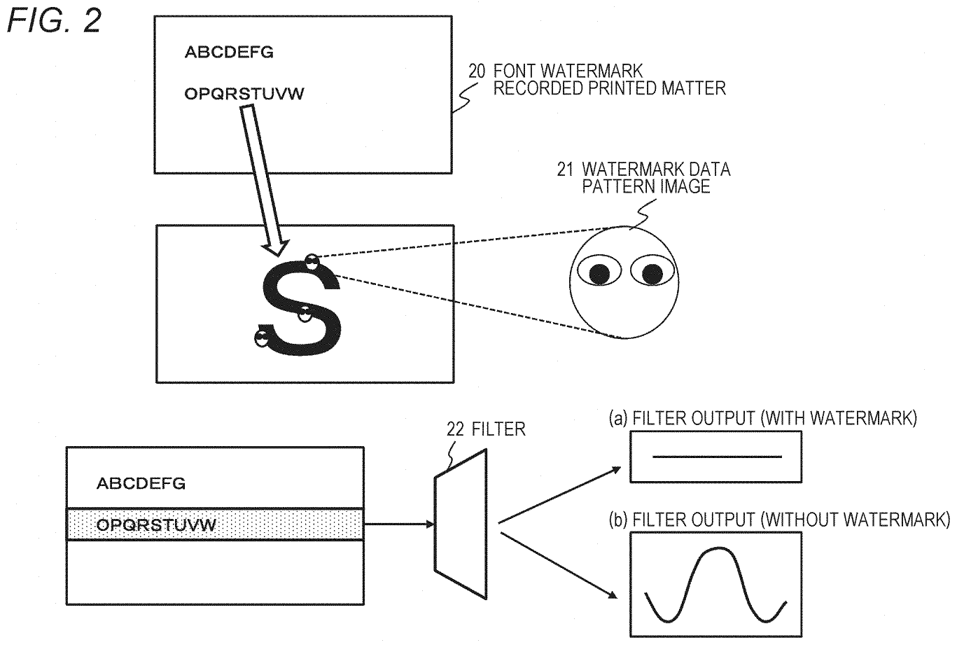

FIG. 2 is a diagram illustrating a specific example of the font watermark.

As described above, the font watermark is a watermark recording method in which information that cannot be recognized in a normal visual recognition state is embedded in a normal print font.

In a font watermark recorded printed matter 20 illustrated in FIG. 2, “ABCDE . . . ” Is recorded as a character string that can be visually recognized. Moreover, a watermark data pattern image 21 illustrated in FIG. 2 is recorded as a font watermark in a part of characters recorded in this printed matter.

The watermark data pattern image 21 illustrated in FIG. 2 is a diagram illustrating an example of a font watermark.

When the character string recorded in the font watermark recorded printed matter 20 is read by a special filter 22, different outputs are obtained in an area where the watermark data pattern image 21 is recorded and an area where it is not recorded as illustrated in the lower part of FIG. 2, and the original on which the watermark data pattern image 21 is recorded can be distinguished.

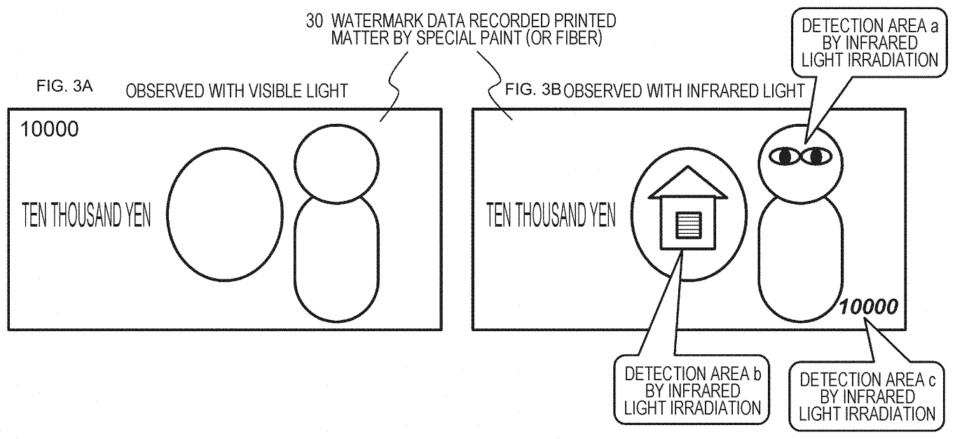

FIG. 3 is a diagram illustrating a watermark recording configuration using a special paint or fiber.

As described above, the configuration using special paint or fiber is a method used for, for example, banknotes or the like, and is a method using, for example, printing or a sheet using paint or fiber that is invisible in visible light but can be detected by infrared rays, ultraviolet rays, or the like other than visible light.

FIG. 3 illustrates a watermark data recorded printed matter 30 by special paint (or fiber).

FIG. 3 illustrates an example of cases where the printed matter is (a) observed with visible light and (b) observed with infrared light.

In the case where the printed matter is (b) observed with infrared light, it is possible to recognize detection areas a, b, and c that have not been possible to be observed in the case where the printed matter is (a) observed with visible light.

Thus, various methods are used to prevent forgery of paper media and to recognize the original.

In the above-mentioned technique, the tint block watermark adds a background constituted of a specific pattern to a printed content and a font watermark alters the printed content itself, and thus both of them have a problem of impairing the appearance of the original printed matter. Furthermore, the watermark recording configuration using special paint or fiber, like those used for banknotes, has a high anti-counterfeiting effect but, on the other hand, has a problem that it is difficult to implement and difficult for general use.

In the following, a configuration of the present disclosure by which the appearance of the printed matter is not impaired and it is easy to embed a watermark will be described.

### 2. Visual Characteristics of Human for Colors

The watermark recording and detection process of the present disclosure are configured by utilizing visual characteristics of human for colors.

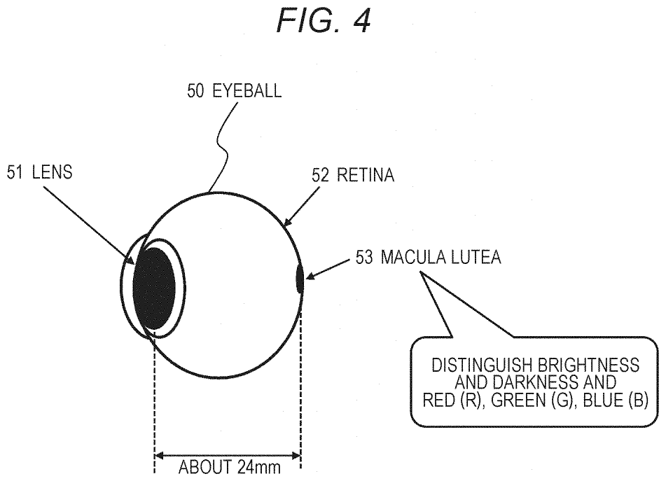

First, the visual characteristics of human for colors will be described with reference to FIG. 4 and so on.

FIG. 4 is a diagram illustrating a cross-sectional configuration of a human eyeball 50.

An input light through a lens 51 is input to a macula lutea 53 on a retina 52. The macula lutea 53 has three types of cone photoreceptor cells that respond to three colors of red (R), green (G), and blue (B), respectively, in addition to cells that distinguish between light and dark.

Lights collected by the lens 51 are focused on the macula lutea 53 region of the retina 52, and cone cells corresponding to respective RGB colors in the macula lutea 53 region react to respective wavelength bands of incident lights, and thus the human can perceive color.

However, the ability of human to perceive color, that is, “wavelength resolution” of light depends on a “viewing angle” and “retinal illuminance”, which is intensity of light reaching the retina.

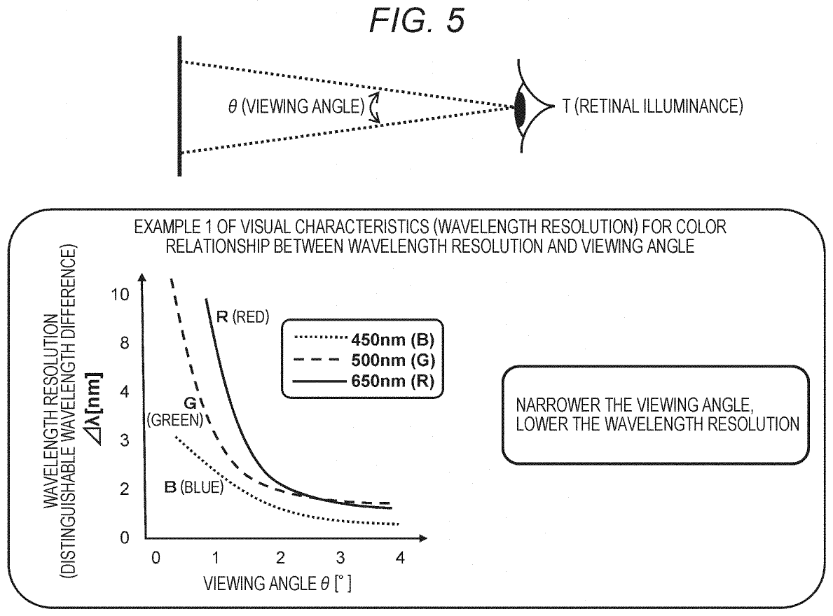

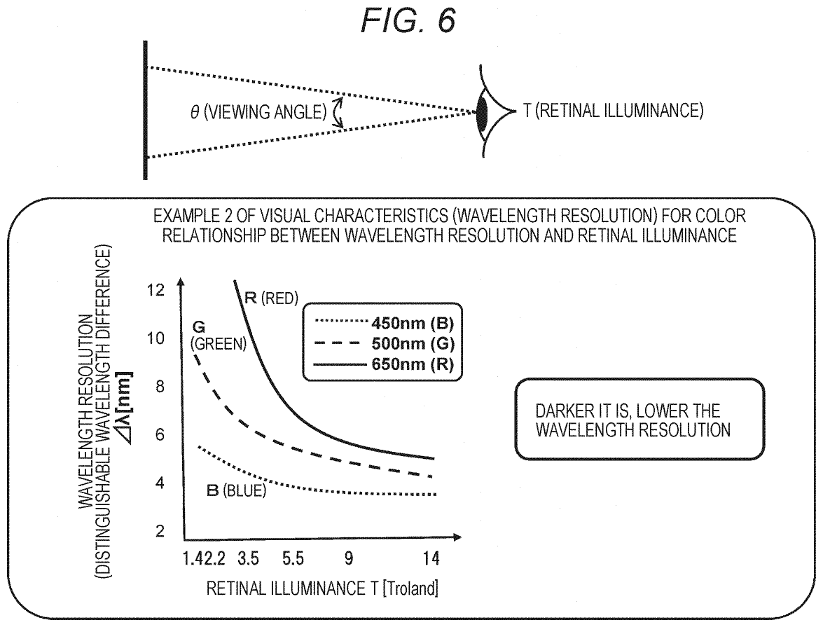

The correspondence between the “wavelength resolution”, the “viewing angle”, and the “retinal illuminance” will be described with reference to FIGS. 5 and 6.

Note that data illustrated in FIGS. 5 and 6 is data disclosed in Non-Patent Document 1 (“On the Hue Discrimination of the Spectrum Color” by Hiroshi Takasaki and Ryuichi Hioki, Journal of the Illumination Engineering Institute of Japan, 1955, Vol. 39, No. 5, pp. 230-235 (https://www.jstage.jst.go.jp/article/jieij1917/39/5/39_5_230/_pdf/-char/ja)).

FIG. 5 is a diagram describing a correspondence between a human color sensing ability, that is, the “wavelength resolution” of light and the “viewing angle”.

The viewing angle (θ) is the angle of a region that a person gazes at. A color change can be recognized in a wide area, but it becomes difficult to recognize a color change in a narrow area.

A graph illustrated in a lower part of FIG. 5 is a graph in which the horizontal axis indicates the viewing angle θ(°) and the vertical axis indicates the wavelength resolution (distinguishable wavelength difference) Δλ (nm).

The graph illustrates a graph of wavelength lights corresponding to respective RGB colors.

R (red)=650 nm

G (green)=500 nm

B (blue)=450 nm

Three lines of these are illustrated.

The three lines illustrated in the graph in the diagram are all downward-sloping lines. That is, the larger the viewing angle, the smaller the wavelength resolution, that is, the distinguishable wavelength difference Δλ (nm). This means that the larger the viewing angle, the smaller the color difference that can be distinguished.

On the other hand, the smaller the viewing angle, the larger the wavelength resolution, that is, the distinguishable wavelength difference Δλ (nm). This means that the smaller the viewing angle, the less distinguishable the color difference is.

Thus, when the angle of a region that a person gazes at, that is, the viewing angle (θ) is wide, it is easy to recognize a color change, but the narrower the viewing angle (θ), the more difficult it is to recognize the color change. That is, the wavelength resolution is reduced.

Next, with reference to FIG. 6, it is a diagram for explaining a correspondence between the human color sensing ability, that is, the “wavelength resolution” of light and “retinal illuminance T”.

FIG. 6 is a diagram describing a correspondence between the human color sensing ability, that is, the “wavelength resolution” of light and “retinal illuminance T”.

The retinal illuminance T is illuminance of light that reaches the retina of human eye. The value of the “retinal illuminance T” increases when looking at a bright object, and decreases in a case of looking at a dark object.

In a case where the value of the “retinal illuminance T” is large, that is, a case of looking at a bright object, it is easy to recognize the color change, but in a case where the value of “retinal illuminance T” is small, that is, a case of looking at a dark object, it becomes difficult to recognize the color change.

A graph illustrated in a lower part of FIG. 6 is a graph in which the horizontal axis indicates the retinal illuminance T (Ttoland) and the vertical axis indicates the wavelength resolution (distinguishable wavelength difference) Δλ (nm).

The graph illustrates a graph of wavelength lights corresponding to respective RGB colors.

R (red)=650 nm

G (green)=500 nm

B (blue)=450 nm

Three lines of these are illustrated.

The three lines illustrated in the graph in the diagram are all downward-sloping lines. That is, the larger (the brighter) the retinal illuminance, the smaller the wavelength resolution, that is, the distinguishable wavelength difference Δλ (nm). This means that the brighter it is, the slighter color differences can be distinguished.

On the other hand, the smaller (darker) the retinal illuminance, the larger the wavelength resolution, that is, the distinguishable wavelength difference Δλ (nm). This means that the darker it is, the less distinguishable the color difference is.

As described above, when the retinal illuminance of a person is large, that is, the observation area is bright, it is easy to recognize the color change, but the smaller the retinal illuminance, that is, the darker the observation area, the more difficult it is to recognize the color change. That is, the wavelength resolution is reduced.

The watermark recording and detection process of the present disclosure has a configuration utilizing the visual characteristics of human for colors illustrated in FIGS. 5 and 6.

### 3. Watermark Recording Process Performed by Watermark Recording Device of Present Disclosure

Next, a watermark recording process executed by the watermark recording device of the present disclosure will be described.

As described with reference to FIGS. 5 and 6, the wavelength resolution of human, that is, the distinguishable wavelength difference Δλ (nm), has a characteristic that it changes depending on the viewing angle and the retinal illuminance.

On the basis of this visual characteristics of human for colors, the following theory holds.

For example, a point (dot) having a color slightly different from that color is recorded in a certain color region printed on a printed matter.

If the wavelength difference Δλ (nm) between the color of this point (dot) and the color around it is equal to or less than the wavelength difference that can be recognized by a person, the person cannot distinguish the existence of the point (dot).

By utilizing this characteristic, it is possible to record information that cannot be visually recognized by normal visual observation on a printed matter without using special paint or fiber.

Thus, the watermark recording device of the present disclosure records, in a certain color region of a printed matter, points (dots) of a color having a wavelength slightly different from the color of the color region.

The color of the watermark dots needs to be determined according to the color of the area where the watermark dots are recorded (hereinafter referred to as an area color or a background color).

The wavelength difference Δλ indicating the degree of color shift between the wavelength of the color of the watermark dots (watermark dot color wavelength) and the wavelength of the color of the area where the watermark dots are recorded (area color wavelength (background color wavelength)) is set to satisfy the following conditions.

(Condition 1) It is less than the wavelength resolution of human eye.

(Condition 2) It is equal to or more than the wavelength resolution of the spectroscopic camera (hyperspectral camera) that captures an image for watermark analysis.

The wavelength resolution of human eye depends on the viewing angle θ and the retinal illuminance t, as described above with reference to FIGS. 5 and 6. Therefore,

(Condition 1) It is less than the wavelength resolution of human eye.

In order to satisfy this condition 1, the wavelength difference Δλ between the watermark dot color wavelength and the area color wavelength of an area where the watermark dots are recorded is only required to be below each line of the graphs illustrated in FIGS. 5 and 6.

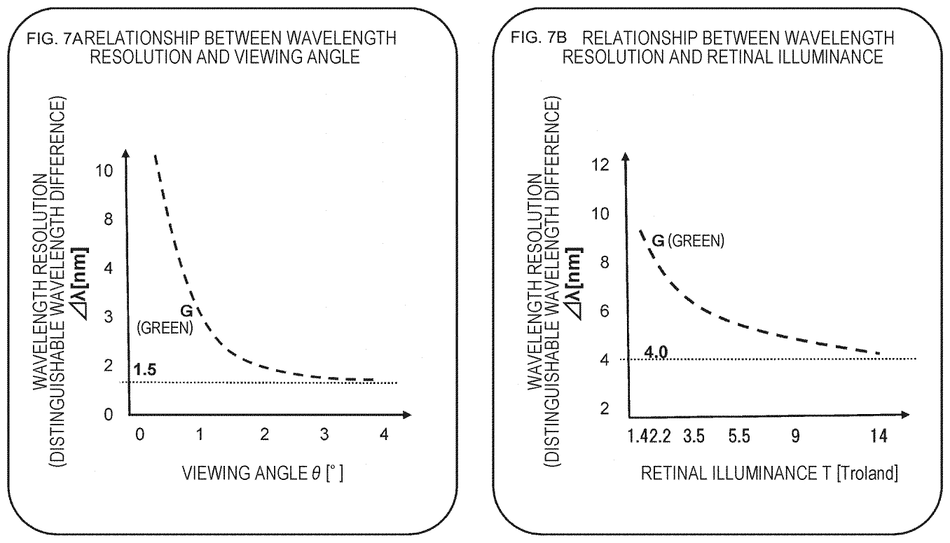

For example, an example of a determination process of watermark dot color in a case where the watermark dots are recorded in an area where an area color of an area for recording the watermark dots is green (G) will be described with reference to FIG. 7.

FIG. 7 illustrates a line corresponding to green (G) in the graphs described above with reference to FIGS. 5 and 6. The graphs illustrate the following two correspondence relationships.

(a) Relationship between the wavelength resolution and the viewing angle

(b) Relationship between the wavelength resolution and the retinal illuminance

The following is analyzed from the relationship between the wavelength resolution and the viewing angle illustrated in (a).

For colors with a wavelength (500 nm) corresponding to green (G), the minimum value of the wavelength resolution (distinguishable wavelength difference) Δλ (nm) is approximately 1.5 nm, and the human is unable to distinguish the color difference of the wavelength difference Δλ<1.5 nm regardless of the viewing angle.

Furthermore, the following is analyzed from the relationship between the wavelength resolution and the retinal illuminance illustrated in (b).

For colors with a wavelength (500 nm) corresponding to green (G), the minimum value of wavelength resolution (distinguishable wavelength difference) Δλ (nm) is approximately 4 nm, the human is unable to distinguish the color difference of the wavelength difference Δλ<4 nm regardless of the magnitude of retinal illuminance (brightness).

On the basis of these two analysis results, in the color area where the area color of the area where the watermark dots are recorded is the wavelength (500 nm) corresponding to green (G), if the wavelength difference Δλ between the watermark dot color wavelength and the area color wavelength (background color wavelength) is set to satisfy this condition:

Δλ<1.5 nm,

the above condition 1, that is,

(Condition 1) it is less than the wavelength resolution of human eye.

This (Condition 1) will be satisfied.

A similar analysis is performed for other color areas so as to calculate the wavelength difference Δλ so that the wavelength difference between the watermark dot color wavelength and the area color wavelength (background color wavelength) in the area where the watermark dots are recorded satisfies (Condition 1) it is less than the wavelength resolution of human eye.

Thus, the set color (color wavelength) of the watermark dots is set to have the wavelength difference Δλ slightly different from the color wavelength of the area color in which the watermark dots are recorded, but the allowable maximum value of this wavelength difference Δλ differs depending on the color of the area color (background color) of the area where the watermark dots are recorded.

As described above, the allowable maximum value of the wavelength difference Δλ between the color wavelength of the watermark dot and the color wavelength of the area color of the area where the watermark dots are recorded can be determined according to the color of the area where the watermark dots are recorded.

On the other hand, the allowable minimum value of the wavelength difference Δλ between the color wavelength of the watermark dots and the color wavelength of the color of the area where the watermark dots are recorded is determined on the basis of the above (Condition 2).

That is,

(Condition 2) it is equal to or higher than the wavelength resolution of the spectroscopic camera (hyperspectral camera) that captures the image for watermark analysis.

On the basis of this (Condition 2), the allowable minimum value of the wavelength difference Δλ between the color wavelength of the watermark dots and the color wavelength of the area where the watermark dots are recorded is determined.

This (condition 2) depends on performance of the spectroscopic camera (hyperspectral camera) that captures the image for watermark analysis. On the basis of specifications of the spectroscopic camera to be used, the allowable minimum value of the wavelength difference Δλ is determined so as to satisfy (Condition 2).

That is, the allowable minimum value of the wavelength difference Δλ between the color wavelength of the watermark dot and the color wavelength of the area color of the area where the watermark dots are recorded is set to be equal to or higher than the wavelength resolution of the spectroscopic camera (hyperspectral camera).

Thus, with the wavelength difference Δλ indicating the degree of color shift between the wavelength of the color of the watermark dots (watermark dot color wavelength) and the wavelength of the color of the area where the watermark dots are recorded (area color wavelength), the allowable maximum value can be determined by the following (Condition 1), and the allowable minimum value can be determined by the following (Condition 2).

(Condition 1) It is less than the wavelength resolution of human eye.

(Condition 2) It is equal to or more than the wavelength resolution of the spectroscopic camera (hyperspectral camera) that captures an image for watermark analysis.

Note that the allowable maximum value determined by (Condition 1) changes according to the color of the area where the watermark dots are recorded.

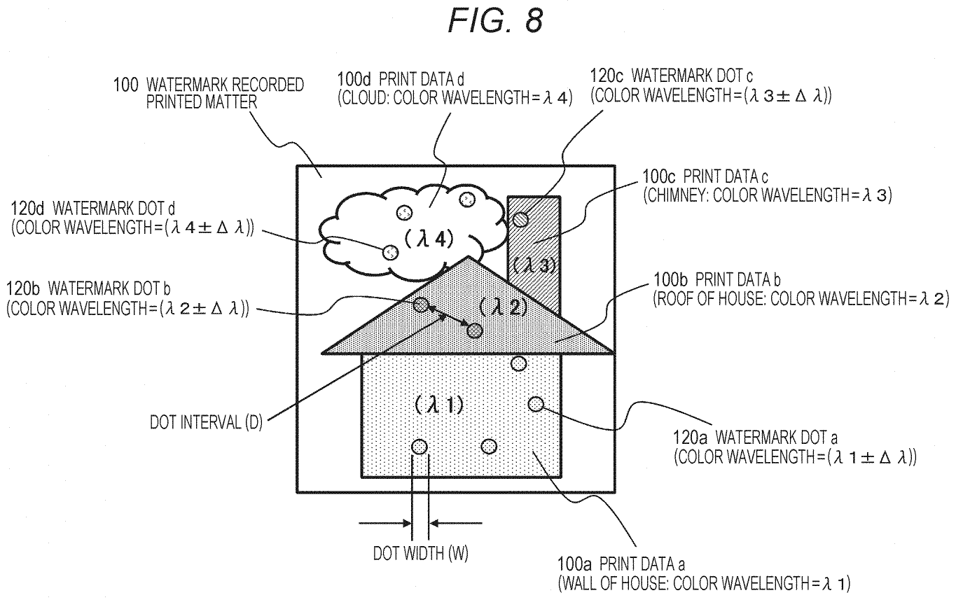

A specific example of the watermark recording process executed by the watermark recording device of the present disclosure will be described with reference to FIG. 8.

FIG. 8 illustrates an example of a watermark recorded printed matter 100 in which watermark dots are recorded.

A house and a cloud are printed on the watermark recorded printed matter 100 as print data that can be visually recognized in a normal observation state.

Watermark dots are recorded in this print data. For the sake of explanation, the watermark dots are illustrated in the diagram so as to look large, but in reality, these watermark dots are small dots and are set to a color that is almost similar to the area color of the area where the watermark dots are recorded, and are points (dots) that can hardly be visually recognized by normal observation.

The print data that can be visually recognized includes the house and cloud, and the house has a wall part, a roof part, and a chimney part. Respective different colors are set to them.

Print data a, 100a is a wall of the house with a color wavelength=λ1.

Print data b, 100b is a roof of the house with a color wavelength=λ2.

Print data c, 100c is a chimney of the house with a color wavelength=λ3.

Print data d, 100d is a cloud with a color wavelength=λ4.

The watermark dots are recorded on each of these print data.

The watermark dots are set to a color close to the color of the print data in a recording target area. Specifically, they are set to a color having a wavelength difference Δλ satisfying the above-mentioned (Condition 1) and (Condition 2) and recorded.

The wavelength difference Δλ is a wavelength difference Δλ between the color wavelength of the watermark dots and the color wavelength of the area color in the area where the watermark dots are recorded.

Note that as described above, the allowable maximum value of the wavelength difference Δλ changes according to the color wavelength of the area color in the area where the watermark dots are recorded.

The watermark dots a, 120a recorded in the print data a, 100a , that is, the area of the wall of the house of a color having a color wavelength=λ1, is recorded as dots having the color of the color wavelength λ1+Δλ or λ1−Δλ.

The watermark dots b, 120b recorded in the print data b, 100b , that is, the area of the roof of the house of a color having a color wavelength=λ2, is recorded as dots having the color of the color wavelength λ2+Δλ or λ2−Δλ.

The watermark dots c, 120c recorded in the print data c, 100c , that is, the area of the chimney of the house of a color having a color wavelength=λ3, is recorded as a dot having the color of the color wavelength λ3+Δλ or λ3−Δλ.

The watermark dots d, 120d recorded in the print data d, 100d , that is, the area of the cloud of a color having a color wavelength=λ4, is recorded as dots having the color of the color wavelength Aλ+Δλ or λ4−Δλ.

The value of Δλ corresponding to each of these areas, that is, the wavelength difference Δλ, is a value that satisfies (Condition 1) and (Condition 2) described above.

Note that the wall, roof, chimney, and cloud of the house have different color wavelengths, and for the value of the wavelength difference Δλ corresponding to each of these areas, the allowable maximum value differs depending on every color wavelength of each area. Therefore, the value of the wavelength difference Δλ corresponding to each area is set to a value equal to or less than the allowable maximum value that differs depending on the color of each area.

The watermark dots are recorded as, for example, circular watermark dots having a constant diameter W, and the interval between the watermark dots is recorded as an interval D.

The diameter W of the watermark dots is determined by, for example, the following calculation formula (Equation 1).

W=Z·tan (θ) (Equation 1)

In the above (Equation 1)

Z represents the distance between the eyes of an observer of a watermark recorded printed matter and the printed matter, and

θ represents the viewing angle.

The observation distance Z and the viewing angle θ vary depending on the observation mode of a person, but the diameter W of the watermark dots is only required to be calculated by setting optimum values of Z and θ according to confidentiality of the watermark dots.

For example, in a case where the confidentiality of the watermark dots is high, the observation distance Z is set small and the viewing angle θ is set large to calculate the diameter W of the watermark dots. In this case, the value of W becomes small.

On the other hand, in a case where the confidentiality of the watermark dots is low and may be of the degree that the points can be seen by looking carefully, the observation distance Z is set large and the viewing angle θ is set small to calculate the diameter W of the watermark dots. In this case, the value of W becomes large.

Note that as the watermark dot interval D, it is only required to select a numerical value larger than the dot diameter W.

Watermark dots with these specifications are recorded on the print data.

### 4. Configuration of Watermark Recording Device of Present Disclosure and Sequence of Processing to be Executed

Next, a configuration of a watermark recording device of the present disclosure and a sequence of processing to be executed will be described.

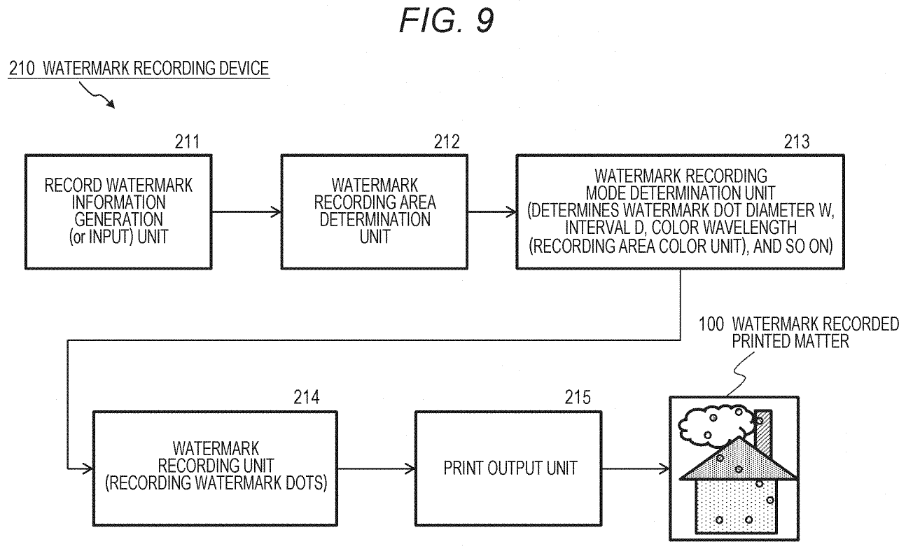

FIG. 9 is a block diagram illustrating a configuration of a watermark recording device 210 of the present disclosure.

As illustrated in FIG. 9, the watermark recording device 210 has a record watermark information generation (or input) unit 211, a watermark recording area determination unit 212, a watermark recording mode determination unit 213, a watermark recording unit 214, and a print output unit 215.

The print output unit 215 outputs a watermark recorded printed matter 100 in which watermark dots are recorded in print data that can be visually recognized.

The record watermark information generation (or input) unit 211 generates data that is a source of watermark information to be recorded on a printed matter, or inputs the data from the outside, and determines a watermark dot pattern corresponding to the recording information.

Examples include special code information, character information, encryption information, and the like. These pieces of information may be generated in the record watermark information generation (or input) unit 211, or may be input from the outside.

The watermark recording area determination unit 212 determines an area on the printed matter where the watermark dot pattern input from the record watermark information generation (or input) unit 211 is recorded.

The watermark recording mode determination unit 213 determines the recording mode of the watermark dots to be recorded on the printed matter.

Specifically, the watermark dot diameter W, the interval D, and the color (color wavelength) are determined. Note that the color (color wavelength) of the watermark dots is determined according to the color of an area in which the watermark dots are recorded.

The watermark recording mode determination unit 213 determines a color (color wavelength) of the watermark dots so as to satisfy the above-described (Condition 1) and (Condition 2).

That is, the wavelength difference Δλ indicating the degree of color shift between the wavelength of the color of the watermark dots (watermark dot color wavelength) and the wavelength of the color of the area where the watermark dots are recorded (area color wavelength (background color wavelength)) is determined to satisfy the following (Condition 1) and (Condition 2).

(Condition 1) It is less than the wavelength resolution of human eye.

(Condition 2) It is equal to or more than the wavelength resolution of the spectroscopic camera (hyperspectral camera) that captures an image for watermark analysis.

As described above, the watermark dot diameter W is determined by the following calculation formula (Equation 1).

W=Z·tan (θ) (Equation 1)

In the above (Equation 1)

Z represents the distance between the eyes of an observer of a watermark recorded printed matter and the printed matter, and

θ represents the viewing angle.

Note that as the observation distance Z and the viewing angle θ, it is only required to use values determined in advance according to confidentiality of watermark dots.

As the watermark dot interval D, a numerical value larger than the dot diameter W is selected.

The watermark recording unit 214 records the watermark dots on the print data according to a watermark dot recording mode (color, diameter, interval) determined by the watermark recording mode determination unit 213.

The print output unit 215 outputs a printed matter having watermark dots recorded by the watermark recording unit 214, that is, a watermark recorded printed matter 100.

Note that the print output unit 215 is not an essential component of the watermark recording device 210, and may be configured to output the watermark recorded printed matter 100 by using an external printing device.

The watermark recorded printed matter 100 generated by the configuration illustrated in FIG. 9 is a printed matter on which the watermark dots that cannot be visually recognized by normal observation are recorded in the print data that can be visually recognized by normal observation.

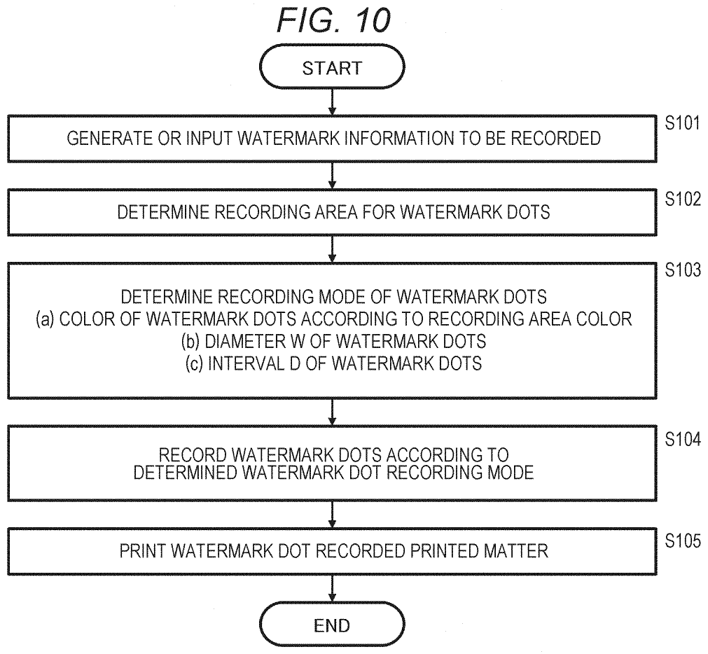

Next, a sequence of processing of generating the watermark recorded printed matter executed by the watermark recording device 120 illustrated in FIG. 9 will be described with reference to a flowchart illustrated in FIG. 10.

Note that the processing according to the flowchart illustrated in FIG. 10 can be executed according to a program stored in a storage unit of the watermark recording device 120, and can be performed as a program execution process by a processor such as a CPU having a program execution function, for example.

Hereinafter, processes of respective steps of the flow illustrated in FIG. 10 will be described.

(Step S101)

First, in step S101, data that is a source of watermark information to be recorded on a printed matter is generated or input from the outside.

This process is a process executed by the record watermark information generation (or input) unit 211 of the watermark recording device 210 illustrated in FIG. 9.

The record watermark information generation (or input) unit 211 generates data that is the source of watermark information to be recorded on the printed matter, or inputs the data from the outside, and determines a watermark dot pattern corresponding to the recording information. Examples include special code information, character information, encryption information, and the like.

(Step S102)

Next, in step S102, an area on the printed matter where the watermark dot pattern is recorded is determined.

This process is a process executed by the watermark recording area determination unit 212 of the watermark recording device 210 illustrated in FIG. 9.

The watermark recording area determination unit 212 determines the area on the printed matter where the watermark dot pattern input from the record watermark information generation (or input) unit 211 is recorded.

(Step S103)

Next, in step S103, the recording mode of the watermark dots to be recorded on the printed matter is determined.

This process is a process executed by the watermark recording mode determination unit 213 of the watermark recording device 210 illustrated in FIG. 9.

The watermark recording mode determination unit 213 determines the recording mode of the watermark dots to be recorded on the printed matter, specifically, the mode as follows.

(a) Color of watermark dots according to recording area color

(b) Diameter W of watermark dots

(c) Interval D of watermark dots

Note that the color (color wavelength) of the watermark dots is determined according to the color of the area in which the watermark dots are recorded.

The watermark recording mode determination unit 213 determines the color (color wavelength) of the watermark dots so as to satisfy the above-mentioned (Condition 1) and (Condition 2).

That is, the wavelength difference Δλ indicating the degree of color shift between the wavelength of the color of the watermark dots (watermark dot color wavelength) and the wavelength of the area color of the area where the watermark dots are recorded (area color wavelength (background color wavelength)) is determined to satisfy the following (Condition 1) and (Condition 2).

(Condition 1) It is less than the wavelength resolution of human eye.

(Condition 2) It is equal to or more than the wavelength resolution of the spectroscopic camera (hyperspectral camera) that captures an image for watermark analysis.

As described above, the watermark dot diameter W is determined by the following calculation formula (Equation 1).

W=Z·tan (θ) (Equation 1)

In the above (Equation 1)

Z represents the distance between the eyes of an observer of a watermark recorded printed matter and the printed matter, and

θ represents the viewing angle.

Note that as the observation distance Z and the viewing angle θ, it is only required to use values determined in advance according to confidentiality of watermark dots.

As the watermark dot interval D, a numerical value larger than the dot diameter W is selected.

(Step S104)

Next, in step S104, the watermark dots are recorded on the print data according to the watermark dot recording mode determined in step S103.

This process is a process executed by the watermark recording unit 214 of the watermark recording device 210 illustrated in FIG. 9.

The watermark recording unit 214 records the watermark dots on the print data according to the watermark dot recording mode (color, diameter, interval) determined by the watermark recording mode determination unit 213 in step S103.

(Step S105)

Next, in step S105, a watermark dot recorded printed matter is printed.

This process is a process executed by the print output unit 215 of the watermark recording device 210 illustrated in FIG. 9.

The print output unit 215 outputs the printed matter having the watermark dots recorded by the watermark recording unit 214 in step S104, that is, the watermark recorded printed matter 100 illustrated in FIGS. 8 and 9.

The watermark recorded printed matter 100 generated by the sequence according to the flow illustrated in FIG. 10 is a printed matter on which the watermark dots that cannot be seen by normal observation are recorded in the print data that can be visually recognized by normal observation.

### 5. Watermark Detection Process Executed by Watermark Detection Device of Present Disclosure

Next, a watermark detection process executed by the watermark detection device of the present disclosure will be described.

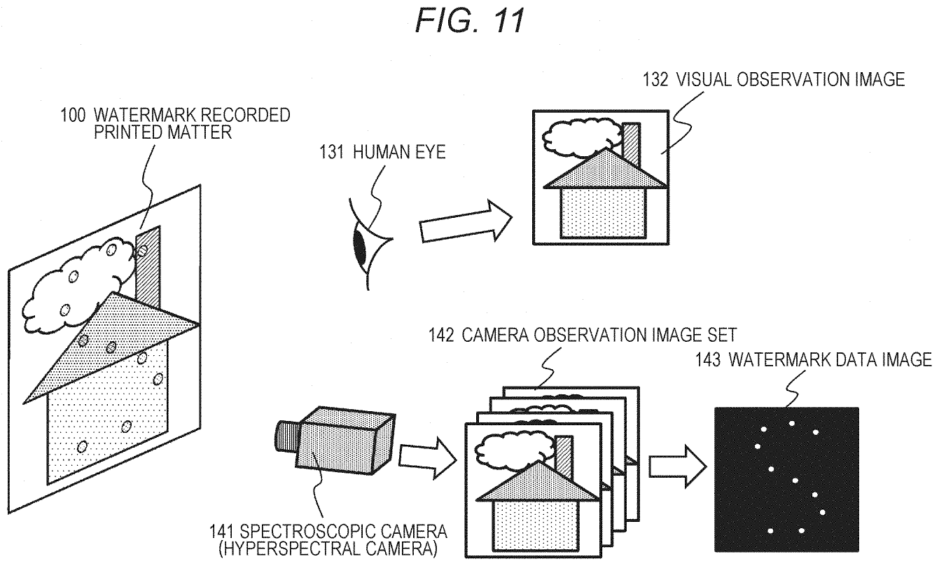

FIG. 11 is a diagram describing a process executed by the watermark detection device of the present disclosure.

As illustrated in FIG. 11, a spectroscopic camera (hyperspectral camera) 141 is used for a detection process for checking whether or not a watermark is recorded on the printed matter.

The spectroscopic camera (hyperspectral camera) 141 is a camera capable of discriminating a wavelength of light that cannot be distinguished by the human eye, that is, a subtle color difference.

For example, an image constituted only of a wavelength light of a specific color can be individually captured.

Specifically, it is a camera that can individually acquire an image in a wavelength light unit of an extremely narrow range, such as an image constituted only of a blue (450 nm) wavelength light, an image constituted only of a green (500 nm) wavelength light, or an image constituted only of a red (650 nm) wavelength light.

The spectroscopic camera (hyperspectral camera) 141 has a specific wavelength resolution as a parameter peculiar to the camera, and has spectroscopic performance corresponding to this resolution, that is, wavelength distinguishing performance.

FIG. 11 illustrates a visual observation image 132 obtained by observing the watermark recorded printed matter 100 with the human eye 131, and a camera observation image set 142 corresponding to a plurality of different wavelength lights (colors) that can be acquired by an imaging process of the spectroscopic camera (hyperspectral camera) 141.

Each of the images constituting the camera observation image set 142 obtained by the imaging process of the spectroscopic camera (hyperspectral camera) 141 is an image constituted only of color components of wavelength lights in a predetermined range. For example, it is constituted of an image constituted only of a blue component near a wavelength light=450 nm, an image constituted only of a green component near a wavelength light=500 nm, an image constituted only of a red component near a wavelength light=650 nm, and the like. Note that in practice, it is constituted of images in finer wavelength component units.

A watermark data image 143 constituted of watermark dot patterns can be generated by image analysis processing using a camera observation image set 142 corresponding to a plurality of different wavelength lights (colors) acquired by image capturing by the spectroscopic camera (hyperspectral camera) 141.

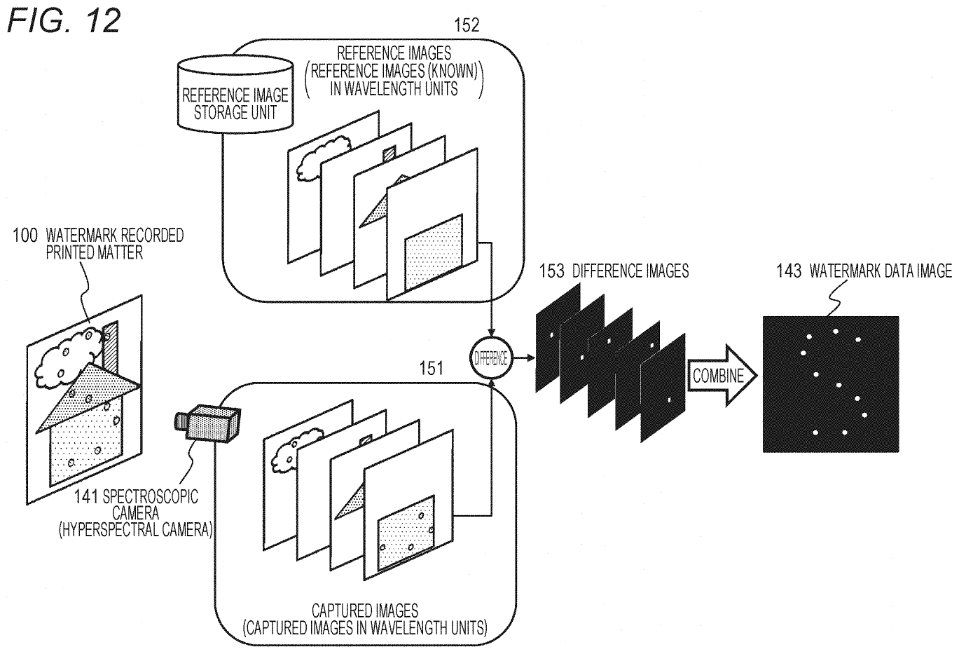

A process of generating the watermark data image 143 executed by the watermark detection device of the present disclosure will be described with reference to FIG. 12.

The watermark recorded printed matter 100 on which watermark dots are recorded is image-captured by the spectroscopic camera (hyperspectral camera) 141.

As captured images 151 of the spectroscopic camera (hyperspectral camera) 141, captured images 151 in different wavelength units (color units) can be obtained.

Each of the captured images 151 in wavelength units (color units) is an image constituted only of color components of wavelength lights in a predetermined range.

On the other hand, reference images 152 are stored in advance in a reference image storage unit.

The reference images 152 are images in wavelength units of a printed matter on which the watermark dots are not recorded.

Each of the reference images 152 in the wavelength unit (color unit) is an image constituted only of color components of wavelength lights in a predetermined range similar to those of the captured images 151.

Next, differences between the captured images 151 of the spectroscopic camera (hyperspectral camera) 141 and images in the same wavelength unit images of the reference images 152 with each other are calculated, and difference images 153 are generated.

The difference images 153 are also generated as a set of difference images in a plurality of wavelength units.

Each of the difference images 153 is an image including watermark dots containing only color components of wavelength lights in a specific range. That is, the watermark dots are recorded only in the captured images 151 of the spectroscopic camera (hyperspectral camera) 141 and not recorded in the reference images 152, and thus only the watermark dots are detected as difference data.

The watermark dots output to the difference images 153 are, for example, binary data with output=1 (white) and output=0 (black) in other areas.

Finally, the watermark data image 143 is generated by combining (summing) all difference images in a plurality of wavelength units, that is, the difference images constituted of the watermark dots of each color wavelength unit, and outputting only the watermark dots recorded on the entire watermark recorded printed matter 100.

Note that similarly to the difference image 153, the watermark data image 143 is binary data in which the watermark dots are set to output=1 (white) and the other areas are set to output=0 (black), and enables visual recognition of the watermark dot pattern by normal observation.

The watermark detection device of the present disclosure detects the watermark dot pattern recorded on the watermark recorded printed matter 100 in this manner.

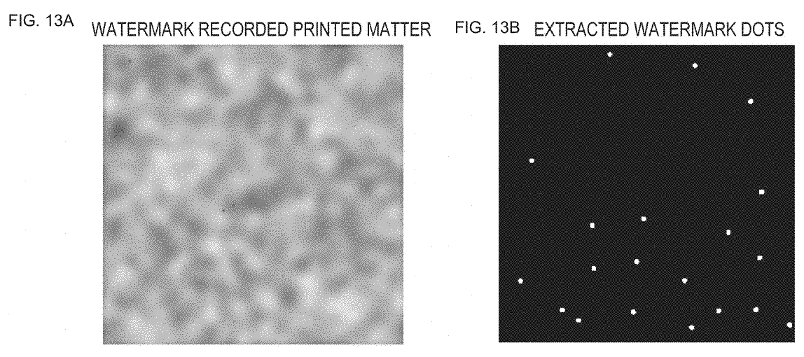

FIG. 13 illustrates actual examples of a printed matter on which the watermark dots are recorded and a watermark dot pattern detected in the printed matter.

FIG. 13 illustrates diagrams of the following two.

(1) Watermark recorded printed matter

(2) Extracted watermark dots

Note that although the (1) watermark recorded printed matter illustrated in FIG. 13 is illustrated as a monochrome image, it is actually a color image and various colors are set in area units. In each area, watermark dots having a color close to the color of that area are recorded.

FIG. 13(2) illustrates a watermark dot pattern detected by the process described with reference to FIGS. 11 and 12.

That is, the image illustrated in FIG. 13(2) is a watermark dot pattern image generated by generating difference images in wavelength units between captured images of the watermark dot recorded printed matter captured by the spectroscopic camera and reference images on which the watermark dots are not recorded, and combining the generated difference images.

Thus, the watermark detection device of the present disclosure can detect the watermark dots that cannot be visually recognized from the watermark recorded printed matter illustrated in FIG. 13(1) and generates the watermark dot pattern image illustrated in FIG. 13(2).

### 6. Configuration of Watermark Detection Device of Present Disclosure and Sequence of Processing to be Executed

Next, the configuration of the watermark detection device of the present disclosure and the sequence of processing to be executed will be described.

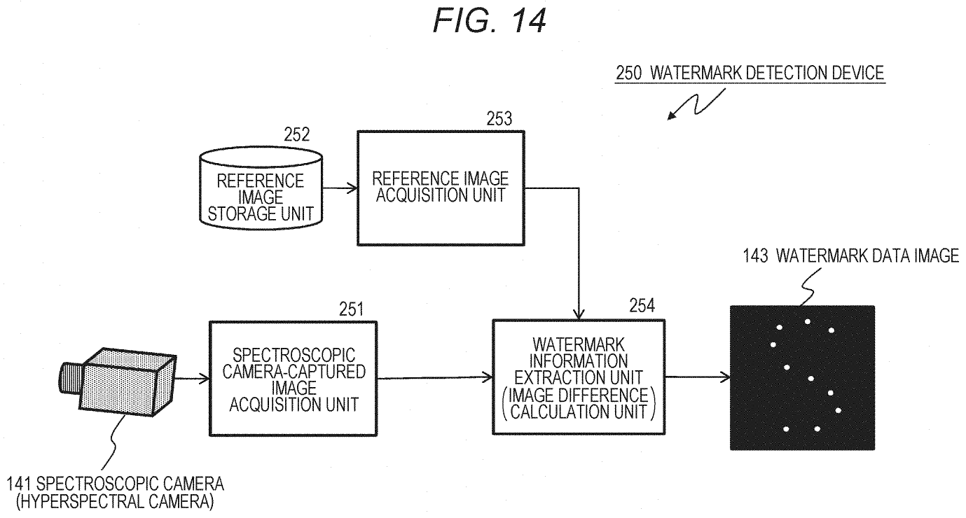

FIG. 14 is a block diagram illustrating a configuration of a watermark detection device 250 of the present disclosure.

As illustrated in FIG. 14, the watermark detection device 250 has a spectroscopic camera-captured image acquisition unit 251 that inputs captured images of the spectroscopic camera (hyperspectral camera) 141, a reference image acquisition unit 253 that acquires reference images from a reference image storage unit 252, and a watermark information extraction unit (image difference calculation unit) 254.

The spectroscopic camera-captured image acquisition unit 251 inputs a captured image of the spectroscopic camera (hyperspectral camera) 141.

As described above, the spectroscopic camera (hyperspectral camera) 141 is a camera capable of discriminating a wavelength of light that cannot be distinguished by the human eye, that is, a subtle color difference, and can individually capture, for example, an image constituted only of a wavelength light of a specific color.

The spectroscopic camera (hyperspectral camera) 141 captures the printed matter on which watermark dots are recorded, that is, the watermark recorded printed matter 100 described above with reference to FIG. 12, and outputs the captured image to the spectroscopic camera-captured image acquisition unit 251.

The spectroscopic camera-captured image acquisition unit 251 acquires a plurality of images constituted only of color components of wavelength lights in a predetermined range obtained by the imaging process of the spectroscopic camera (hyperspectral camera) 141. That is, the captured images 151 in different wavelength units (color units) described with reference to FIG. 12 are acquired.

The reference image acquisition unit 253 acquires reference images from the reference image storage unit 252.

In the reference image storage unit 252, images in wavelength units of a printed matter on which watermark dots are not recorded are recorded. Note that this printed matter corresponds to a printed matter in which the watermark dots are removed from the watermark recorded printed matter 100 imaged by the spectroscopic camera (hyperspectral camera) 141.

The reference image acquisition unit 253 acquires reference images, which are images in wavelength units of a printed matter on which the watermark dots are not recorded, from the reference image storage unit 252. The reference images acquired by the reference image acquisition unit 253 from the reference image storage unit 252 correspond to the reference images 152 described with reference to FIG. 12.

The watermark information extraction unit (image difference calculation unit) 254 calculates differences between captured images in wavelength units (color units) acquired by the spectroscopic camera-captured image acquisition unit 251 and the reference images in wavelength units (color units) acquired by the reference image acquisition unit 253 from the reference image storage unit 252 between images in the same wavelength units, and generates difference images in respective wavelength units. Moreover, the watermark information extraction unit (image difference calculation unit) 254 combines (sums) the calculated difference images in a plurality of wavelength units to generate the watermark data image 143.

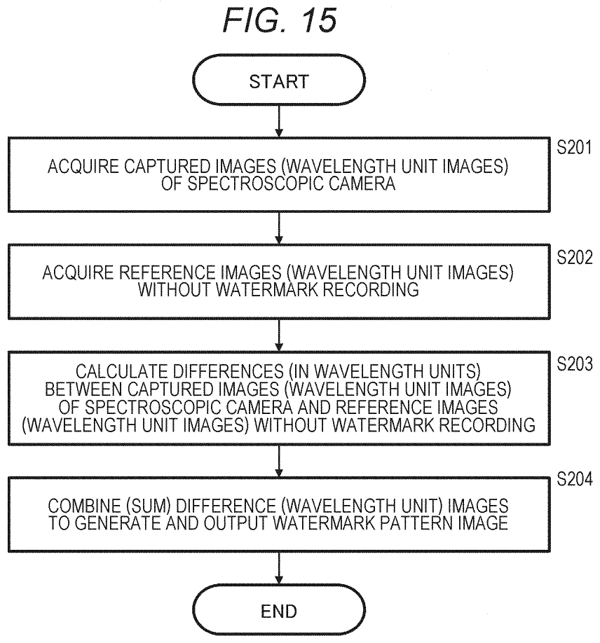

Next, a sequence of the watermark detection process executed by the watermark detection device 250 illustrated in FIG. 14 will be described with reference to a flowchart illustrated in FIG. 15.

Note that the processing according to the flowchart illustrated in FIG. 15 can be executed according to a program stored in a storage unit of the watermark detection device 250, and can be performed as a program execution process by a processor such as a CPU having a program execution function, for example.

Hereinafter, processes of respective steps of the flow illustrated in FIG. 15 will be described.

(Step S201)

First, in step S201, wavelength unit images which are captured images of the spectroscopic camera (hyperspectral camera) 141 are acquired.

This process is executed by the spectroscopic camera-captured image acquisition unit 251 of the watermark detection device 250 illustrated in FIG. 14.

The spectroscopic camera (hyperspectral camera) captures images of the printed matter on which watermark dots are recorded, that is, the watermark recorded printed matter 100 described above with reference to FIG. 12, and outputs the captured images to the spectroscopic camera-captured image acquisition unit 251.

In step S201, the spectroscopic camera-captured image acquisition unit 251 acquires a plurality of images constituted only of color components of wavelength lights in a predetermined range obtained by the imaging process of the spectroscopic camera (hyperspectral camera) 141. That is, the captured images 151 in different wavelength units (color units) described with reference to FIG. 12 are acquired.

(Step S202)

Next, in step S202, reference images (wavelength unit images) without watermark recording are acquired.

This process is a process executed by the reference image acquisition unit 253 of the watermark detection device 250 illustrated in FIG. 14.

The reference image acquisition unit 253 acquires the reference images from the reference image storage unit 252 as described with reference to FIG. 14.

In the reference image storage unit 252, images in wavelength units of a printed matter on which watermark dots are not recorded are recorded.

In step S202, the reference image acquisition unit 253 acquires the reference image, which is an image in a wavelength unit of a printed matter on which the watermark dots are not recorded, from the reference image storage unit 252.

(Step S203)

Next, in step S203, difference images (wavelength unit difference images) between the captured images (wavelength unit images) of the spectroscopic camera (hyperspectral camera) and the reference images (wavelength unit images) without watermark recording are calculated.

This process is a process executed by the watermark information extraction unit (image difference calculation unit) 254 of the watermark detection device 250 illustrated in FIG. 14.

The watermark information extraction unit (image difference calculation unit) 254 calculates differences between captured images in wavelength units (color units) acquired by the spectroscopic camera-captured image acquisition unit 251 and the reference images in wavelength units (color units) acquired by the reference image acquisition unit 253 from the reference image storage unit 252 between images in the same wavelength units, and generates difference images in respective wavelength units.

(Step S204)

Next, in step S204, the difference images (wavelength unit difference images) generated in step S203 are combined (summed) to generate a watermark pattern image.

This process is also a process executed by the watermark information extraction unit (image difference calculation unit) 254 of the watermark detection device 250 illustrated in FIG. 14.

The watermark information extraction unit (image difference calculation unit) 254 combines (sums) the difference images in a plurality of wavelength units calculated in step S203 to generate a watermark pattern image, that is, the watermark data image 143 illustrated in FIG. 14.

Thus, the watermark detection device of the present disclosure executes the detection process of the watermark dot pattern recorded on the watermark recorded printed matter 100, which cannot be visually recognized by normal observation.

### 7. Other Embodiments

Next, embodiments different from the above-described embodiment will be described.

With the configuration of the above-described embodiment, as watermark dots to be recorded on a printed matter, the watermark dots having a color slightly different from the color of the area where the watermark dots are recorded are recorded.

The watermark dots recorded on the printed matter are not limited to the mode in which a color is thus set to be slightly different from a color of an embedded area, and may be, for example, dots having a brightness slightly different from the brightness of the embedded area.

Furthermore, in the above-described example, only the example of recording the watermark dots on the printed matter has been described, but for example, the watermark dots may be recorded on the image data.

For example, a configuration may be employed in which watermark dots similar to those described above may be recorded in image data such as a movie or a picture.

For example, crimes such as secretly shooting a movie shown in a movie theater with a camera and creating and distributing copy data occur frequently.

It is difficult for a general camera to distinguish between the color of watermark dots and the color of an area where the watermark dots are recorded, and as a consequence, the watermark dots cannot be detected from an image taken by the general camera, making it possible to determine that it is a copy image.

As described above, the processing of the present disclosure is not limited to printed matters but is applicable to image data such as still images and moving images, and can be used for detecting illegally reproduced images, for example.

### 8. Hardware Configuration Example of Watermark Recording Device and Watermark Detection Device

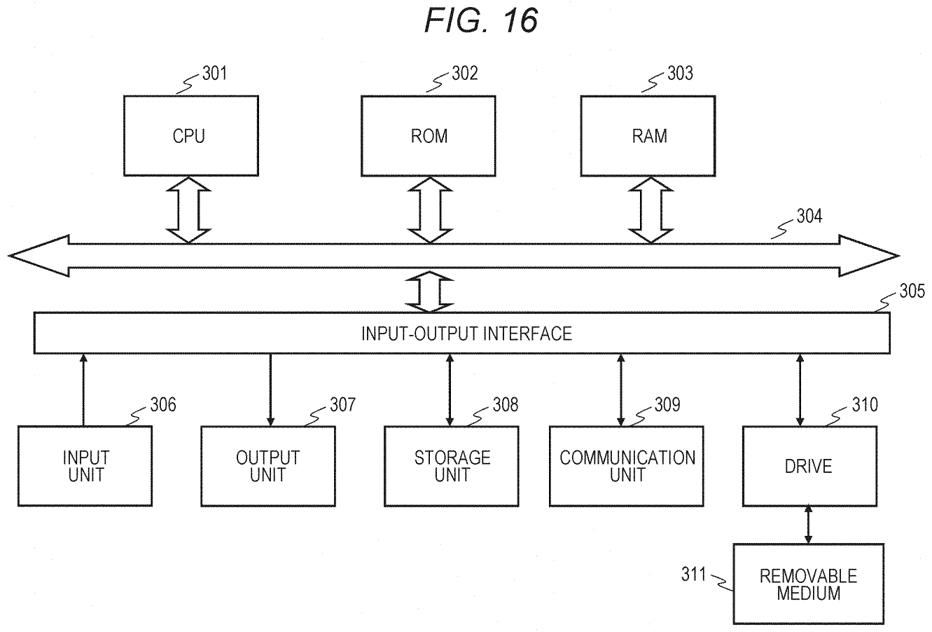

Next, with reference to FIG. 16, a configuration example of a hardware configuration of the watermark recording device and the watermark detection device of the present disclosure will be described.

A central processing unit (CPU) 301 functions as a control unit and a data processing unit that executes various processes according to a program stored in a read only memory (ROM) 302 or a storage unit 308. For example, processes according to the sequences described in the above-described embodiment are executed. A random access memory (RAM) 303 stores programs, data, and the like to be executed by the CPU 301. The CPU 301, the ROM 302, and the RAM 303 are connected to each other by a bus 304.

The CPU 301 is connected to an input-output interface 305 via the bus 304, and to the input-output interface 305, an input unit 306 that includes various switches, a keyboard, a mouse, a microphone, a camera, a sensor, and the like, and an output unit 307 that includes a display, a speaker, and the like are connected. The CPU 301 executes various processes corresponding to a command input from the input unit 306, and outputs a processing result to the output unit 307, for example.

The storage unit 308 connected to the input-output interface 305 includes, for example, a hard disk and the like and stores programs executed by the CPU 301 and various data. The communication unit 309 functions as a transmission-reception unit for Wi-Fi communication, Bluetooth (registered trademark) (BT) communication, and other data communication via a network such as the Internet or a local area network, and communicates with an external device.

A drive 310 connected to the input-output interface 305 drives a removable medium 311 such as a magnetic disk, an optical disk, a magneto-optical disk, or a semiconductor memory such as a memory card, and executes recording or reading of data.

### 9. Summary of Configuration of Present Disclosure

As described above, the embodiment of the present disclosure has been described in detail with reference to a particular embodiment. However, it is obvious that those skilled in the art can make modifications and substitutions of the embodiment without departing from the gist of the present disclosure. In other words, the present invention has been disclosed in the form of exemplification, and should not be interpreted in a limited manner. In order to determine the gist of the present disclosure, the claims should be taken into consideration.

Note that the technology disclosed in the present description can take the following configurations.

(1) A watermark recording device having a watermark recording unit that records watermark dots having a color having a small difference from an area color of an area in which a watermark is recorded.

(2) The watermark recording device according to (1), further including a watermark recording mode determination unit that determines a color of the watermark dots,

in which the watermark recording mode determination unit determines a color of the watermark dots in such a way that a wavelength difference Δλ, which is a difference between a color wavelength of the watermark dots and an area color wavelength of a recording area of the watermark dots, is less than a wavelength resolution of human eye.

(3) The watermark recording device according to (2), in which the watermark recording mode determination unit determines the color of the watermark dots in such a way that the wavelength difference Δλ is equal to or higher than a wavelength resolution of a spectroscopic camera (hyperspectral camera) that captures an image for watermark analysis.

(4) The watermark recording device according to (2) or (3), in which the watermark recording mode determination unit determines a diameter W and an interval D of the watermark dots.

(5) The watermark recording device according to any one of (2) to (4), in which the watermark recording mode determination unit calculates a diameter W of the watermark dots according to an equation below,

W=Z·tan (θ)

where Z represents a distance between a human eye observing a watermark recorded printed matter and the printed matter, and θ is a viewing angle.

(6) The watermark recording device according to any one of (2) to (5), in which the watermark recording mode determination unit sets the wavelength difference Δλ to a different value according to the area color of the recording area of the watermark dots and determines the color of the watermark dots.

(7) The watermark recording device according to any one of (1) to (6), in which the watermark recording device records the watermark dots on a printed matter.

(8) The watermark recording device according to any one of (1) to (6), in which the watermark recording device records the watermark dots on an image.

(9) A watermark detection device having:

a spectroscopic camera-captured image acquisition unit that acquires a captured image obtained by capturing a watermark recorded printed matter on which watermark dots are recorded by a spectroscopic camera;

a reference image acquisition unit that acquires a reference that is an image of a printed matter on which the watermark dots are not recorded; and

a watermark information extraction unit that calculates a difference between the captured image and the reference image and detects the watermark dots.

(10) The watermark detection device according to (9), in which

the spectroscopic camera-captured image acquisition unit acquires a plurality of captured images in a wavelength unit captured by a spectroscopic camera,

the reference image acquisition unit acquires a plurality of reference images in wavelength units, which is images of a printed matter on which the watermark dots are not recorded, and

the watermark information extraction unit generates a difference image in a wavelength unit from the captured image and each of an image set of a same wavelength of the reference image, and combines difference images in a plurality of wavelength units to detect all watermark dots recorded on the watermark recorded printed matter.

(11) A watermark recorded printed matter including watermark dots that are recorded thereon and have a color having a small difference from an area color of a print data area in the printed matter.

(12) The watermark recorded printed matter according to (11), in which a wavelength difference Δλ, which is a difference between a color wavelength of the watermark dots and an area color wavelength of a recording area of the watermark dots, is less than a wavelength resolution of human eye.

(13) The watermark recorded printed matter according to (12), in which the wavelength difference Δλ is equal to or higher than a wavelength resolution of a spectroscopic camera (hyperspectral camera) that captures an image for watermark analysis.

(14) A watermark recording method executed in a watermark recording device, the method including, by a watermark recording unit, recording watermark dots having a color having a small difference from an area color of an area in which a watermark is recorded.

(15) A watermark detection method executed by a watermark detection device, the method including:

a step in which a spectroscopic camera-captured image acquisition unit acquires a captured image obtained by capturing a watermark recorded printed matter on which watermark dots are recorded by a spectroscopic camera;

a step in which a reference image acquisition unit acquires a reference that is an image of a printed matter on which the watermark dots are not recorded; and

by a watermark information extraction unit, calculating a difference between the captured image and the reference image and detecting the watermark dots.

(16) A program that causes a watermark recording device to execute a watermark recording process including causing a watermark recording unit to record watermark dots having a color having a small difference from an area color of an area in which a watermark is recorded.

(17) A program that causes a watermark detection device to execute a watermark detection process including:

a step of causing a spectroscopic camera-captured image acquisition unit to acquire a captured image obtained by capturing a watermark recorded printed matter on which watermark dots are recorded by a spectroscopic camera;

a step of causing a reference image acquisition unit to acquire a reference that is an image of a printed matter on which the watermark dots are not recorded; and

causing a watermark information extraction unit to calculate a difference between the captured image and the reference image and detect the watermark dots.

Furthermore, a series of processes described in the description can be executed by hardware, software, or a combined configuration of the both. In a case of executing processes by software, a program recording a processing sequence can be installed and run on a memory in a computer incorporated in dedicated hardware, or the program can be installed and run on a general-purpose computer capable of executing various processes. For example, the program can be recorded in advance on a recording medium. In addition to being installed on a computer from a recording medium, the program can be received via a network such as a local area network (LAN) or the Internet and installed on a recording medium such as an internal hard disk.

Note that the various processes described in the description are not only executed in time series according to the description, but may be executed in parallel or individually according to processing capability of the apparatus that executes the processes or as necessary. Furthermore, a system in the present description is a logical set configuration of a plurality of devices, and is not limited to one in which devices with respective configurations are in the same housing.

### INDUSTRIAL APPLICABILITY

As described above, with a configuration of one embodiment of the present disclosure, there is provided a device and a method that achieve a watermark that can be easily recorded and does not significantly impair the appearance of a printed matter.

Specifically, for example, a watermark recording unit that records watermark dots having a color having a small difference from an area color of an area in which a watermark is recorded, and a watermark recording mode determination unit that determines a color of the watermark dots are included. The watermark recording mode determination unit determines a color of the watermark dots in such a way that a wavelength difference Δλ, which is a difference between a color wavelength of the watermark dots and an area color wavelength of a recording area of the watermark dots, is less than a wavelength resolution of human eye. Moreover, the color of the watermark dots is determined in such a way that the wavelength difference Δλ is equal to or higher than a wavelength resolution of a spectroscopic camera (hyperspectral camera) that captures an image for watermark analysis.

This configuration provides a device and a method for achieving a watermark recording process and a detection process by which both the recording process and the detection process are easy.

### REFERENCE SIGNS LIST

10 Tint block watermark recorded printed matter
11 Tint block watermark data record pattern
20 Font watermark recorded printed matter
21 Watermark data pattern image
22 Filter
30 Watermark data recorded printed matter with special paint (or fiber)
50 Eyeball
51 Lens
52 Retina
53 Macula lutea
100 Watermark recorded printed matter
120 Watermark dot
141 Spectroscopic camera (hyperspectral camera)
142 Camera observation image set
143 Watermark data image
151 Captured image
152 Reference image
153 Difference image
210 Watermark recording device
211 Record watermark information generation (or input) unit
212 Watermark recording area determination unit
213 Watermark recording mode determination unit
214 Watermark recording unit
215 Print output unit
250 Watermark detection device
251 Spectroscopic camera-captured image acquisition unit
252 Reference image storage unit
253 Reference image acquisition unit
254 Watermark information extraction unit (image difference calculation unit)
301 CPU
302 ROM
303 RAM
304 Bus
305 Input-output interface
306 Input unit
307 Output unit
308 Storage unit
309 Communication unit
310 Drive
311 Removable medium

1. A watermark recording device comprising a watermark recording unit that records watermark dots having a color having a small difference from an area color of an area in which a watermark is recorded.

2. The watermark recording device according to claim 1, further comprising a watermark recording mode determination unit that determines a color of the watermark dots,
wherein the watermark recording mode determination unit determines a color of the watermark dots in such a way that a wavelength difference Δλ, which is a difference between a color wavelength of the watermark dots and an area color wavelength of a recording area of the watermark dots, is less than a wavelength resolution of human eye.

3. The watermark recording device according to claim 2, wherein the watermark recording mode determination unit determines the color of the watermark dots in such a way that the wavelength difference Δλ is equal to or higher than a wavelength resolution of a spectroscopic camera (hyperspectral camera) that captures an image for watermark analysis.

4. The watermark recording device according to claim 2, wherein the watermark recording mode determination unit determines a diameter W and an interval D of the watermark dots.

5. The watermark recording device according to claim 2, wherein the watermark recording mode determination unit calculates a diameter W of the watermark dots according to an equation below,
W=Z·tan (θ)
where Z represents a distance between a human eye observing a watermark recorded printed matter and the printed matter, and θ is a viewing angle.

6. The watermark recording device according to claim 2, wherein the watermark recording mode determination unit sets the wavelength difference Δλ to a different value according to the area color of the recording area of the watermark dots and determines the color of the watermark dots.

7. The watermark recording device according to claim 1, wherein the watermark recording device records the watermark dots on a printed matter.

8. The watermark recording device according to claim 1, wherein the watermark recording device records the watermark dots on an image.

9. A watermark detection device comprising:
a spectroscopic camera-captured image acquisition unit that acquires a captured image obtained by capturing a watermark recorded printed matter on which watermark dots are recorded by a spectroscopic camera;
a reference image acquisition unit that acquires a reference that is an image of a printed matter on which the watermark dots are not recorded; and
a watermark information extraction unit that calculates a difference between the captured image and the reference image and detects the watermark dots.

10. The watermark detection device according to claim 9, wherein
the spectroscopic camera-captured image acquisition unit acquires a plurality of captured images in a wavelength unit captured by a spectroscopic camera,
the reference image acquisition unit acquires a plurality of reference images in wavelength units, which is images of a printed matter on which the watermark dots are not recorded, and
the watermark information extraction unit generates a difference image in a wavelength unit from the captured image and each of an image set of a same wavelength of the reference image, and combines difference images in a plurality of wavelength units to detect all watermark dots recorded on the watermark recorded printed matter.

11. A watermark recorded printed matter comprising watermark dots that are recorded thereon and have a color having a small difference from an area color of a print data area in the printed matter.

12. The watermark recorded printed matter according to claim 11, wherein a wavelength difference Δλ, which is a difference between a color wavelength of the watermark dots and an area color wavelength of a recording area of the watermark dots, is less than a wavelength resolution of human eye.

13. The watermark recorded printed matter according to claim 12, wherein the wavelength difference Δλ is equal to or higher than a wavelength resolution of a spectroscopic camera (hyperspectral camera) that captures an image for watermark analysis.

14. A watermark recording method executed in a watermark recording device, the method comprising, by a watermark recording unit, recording watermark dots having a color having a small difference from an area color of an area in which a watermark is recorded.

15. A watermark detection method executed by a watermark detection device, the method comprising:
a step in which a spectroscopic camera-captured image acquisition unit acquires a captured image obtained by capturing a watermark recorded printed matter on which watermark dots are recorded by a spectroscopic camera;
a step in which a reference image acquisition unit acquires a reference that is an image of a printed matter on which the watermark dots are not recorded; and
by a watermark information extraction unit, calculating a difference between the captured image and the reference image and detecting the watermark dots.

16. A program that causes a watermark recording device to execute a watermark recording process comprising causing a watermark recording unit to record watermark dots having a color having a small difference from an area color of an area in which a watermark is recorded.

17. A program that causes a watermark detection device to execute a watermark detection process comprising:
a step of causing a spectroscopic camera-captured image acquisition unit to acquire a captured image obtained by capturing a watermark recorded printed matter on which watermark dots are recorded by a spectroscopic camera;
a step of causing a reference image acquisition unit to acquire a reference that is an image of a printed matter on which the watermark dots are not recorded; and
causing a watermark information extraction unit to calculate a difference between the captured image and the reference image and detect the watermark dots.
